(19) United States
(12) Patent Application Publication
(10) Pub. No.: US 2024/0340741 A1
(43) Pub. Date: Oct. 10, 2024

(54) METHOD FOR WIRELESS COMMUNICATION, AND DEVICE

(71) Applicant: GUANGDONG OPPO MOBILE TELECOMMUNICATIONS CORP., LTD., Dongguan (CN)

(72) Inventors: Bingxue LENG, Dongguan (CN); Qianxi LU, Dongguan (CN); Shichang ZHANG, Dongguan (CN)

(21) Appl. No.: 18/745,975

(22) Filed: Jun. 17, 2024

Related U.S. Application Data
(63) Continuation of application No. PCT/CN2021/139953, filed on Dec. 21, 2021.

(51) Int. Cl. H04W 36/24; H04W 36/36

(52) U.S. Cl. CPC H04W 36/24; H04W 36/36

(57) ABSTRACT

A method for wireless communication and a device are provided in embodiments of the disclosure. A first terminal generates coordination information. The first terminal sends the coordination information to a second terminal. The coordination information is used for coordinating with the second terminal to perform resource selection or resource reselection. The coordination information is generated under triggering of a preset condition, or the coordination information is sent under triggering of the preset condition.

### CROSS-REFERENCE TO RELATED APPLICATION(S)

This application is a continuation of International Application No. PCT/CN2021/139953, filed Dec. 21, 2021, the entire disclosure of which is incorporated herein by reference.

### TECHNICAL FIELD

Embodiments of the disclosure relate to the field of communications, and in particular, to a method for wireless communication and a device.

### BACKGROUND

In sidelink communication, two transmission modes, i.e., a first mode and a second mode, are defined in 3rd generation partnership project (3GPP). In the first mode, a transmission resource for a terminal is allocated by a network device, and the first mode is also referred to as mode 3 in long-term evolution (LTE)-vehicle to everything (V2X). In the second mode, the terminal selects a resource from a resource pool to perform data transmission, and the second mode is also referred to as mode 4 in the LTE-V2X. Based on mode 4 in the LTE-V2X, 3GPP re-discusses and designs a resource selection solution applicable to new radio (NR)-V2X, which is recorded as mode 2.

In mode 2, problems, such as excessive power consumption and relatively long transmission delay of a terminal device, are caused due to problems such as half-duplex, a hidden node, and resource collision. On this basis, a coordination mechanism between terminal devices is introduced in release (R) 17. The coordination mechanism mainly is that terminal A can send coordination information to terminal B. The coordination information includes at least one of: a set of resources that terminal A expects terminal B to use; a set of resources that terminal A does not expect terminal B to use; or a set of resources with a resource conflict. After receiving the coordination information, terminal B may perform resource selection or resource reselection according to the coordination information. However, how to generate and transmit coordination information is not disclosed at present.

### SUMMARY

In a first aspect, a method for wireless communication is provided. The method includes the following. A first terminal generates coordination information. The first terminal sends the coordination information to a second terminal. The coordination information is used for coordinating with the second terminal to perform resource selection or resource reselection. The coordination information is generated under triggering of a preset condition, or the coordination information is sent under triggering of the preset condition.

In a second aspect, a terminal device is provided. The terminal device is a first terminal and includes a processor and a memory. The memory is configured to store computer programs. The processor is configured to invoke and execute the computer programs stored in the memory to receive coordination information sent by a first terminal; and perform resource selection or resource reselection according to the coordination information. The coordination information is generated under triggering of a preset condition, or the coordination information is sent under triggering of the preset condition

In a third aspect, a chip is provided. The chip includes a processor, and the processor is configured to invoke and execute computer programs stored in a memory, to enable a first terminal equipped with the chip to: generate coordination information; and send the coordination information to a second terminal. The coordination information is used for coordinating with the second terminal to perform resource selection or resource reselection. The coordination information is generated under triggering of a preset condition, or the coordination information is sent under triggering of the preset condition.

### BRIEF DESCRIPTION OF THE DRAWINGS

FIG. 1 is a schematic diagram illustrating a first mode provided in the disclosure.

FIG. 2 is a schematic diagram illustrating a second mode provided in the disclosure.

FIG. 3A is an interactive flowchart illustrating a method for wireless communication provided in embodiments of the disclosure.

FIG. 3B is an interactive flowchart illustrating another method for wireless communication provided in embodiments of the disclosure.

FIG. 4 is a schematic block diagram illustrating a terminal device 400 according to embodiments of the disclosure.

FIG. 5 is a schematic block diagram illustrating a terminal device 500 according to embodiments of the disclosure.

FIG. 6 is a schematic structural diagram illustrating a communication device 600 provided in embodiments of the disclosure.

FIG. 7 is a schematic structural diagram illustrating an apparatus provided in embodiments of the disclosure.

FIG. 8 is a schematic block diagram illustrating a communication system 800 provided in embodiments of the disclosure.

### DETAILED DESCRIPTION

The following will illustrate technical solutions of embodiments of the disclosure with reference to accompanying drawings of embodiments of the disclosure. Apparently, embodiments illustrated herein are some, rather than all embodiments, of the disclosure. Based on the embodiments of the disclosure, all other embodiments obtained by those of ordinary skill in the art without creative effort shall fall within a scope of protection of the disclosure. Before introducing the technical solutions of the disclosure, related concepts of the disclosure are described below.

### I. Long-Term Evolution (LTE) Terminal to Terminal (Device to Device (D2D))/Vehicle to Everything (V2X)

D2D communication is a D2D-based sidelink (SL) transmission technology. Unlike a mode in which communication data is received or sent via a base station in a conventional cellular system, D2D communication has relatively high spectral efficiency and relatively low transmission delay. A terminal-to-terminal direct communication mode is adopted in an internet of vehicles (IoV) system, and two transmission modes, i.e., a first mode and a second mode, are defined in 3rd generation partnership project (3GPP).

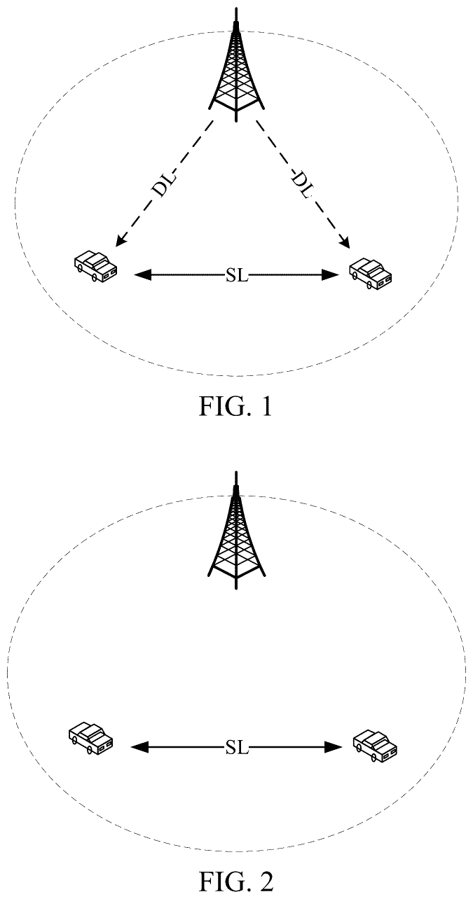

In the first mode, as illustrated in FIG. 1, a transmission resource for a terminal is allocated by a network device, and the terminal performs data transmission on SL according to the resource allocated by the network device. The network device may allocate to the terminal a resource for single transmission or a resource for semi-persistent transmission. The first mode is also referred to as mode 3 in LTE-V2X.

In the second mode, as illustrated in FIG. 2, the terminal selects a resource from a resource pool to perform data transmission. The second mode is also referred to as mode 4 in LTE-V2X.

D2D has been studied in different stages in 3GPP.
1. Proximity based Service (ProSe): in release (R) 12/13, D2D communication is studied for a ProSe scenario, which mainly aims at public-security-type services. In the ProSe, a time-domain position of a resource pool is configured. For example, the resource pool is discontinuous in the time domain, so that a terminal device can discontinuously send/receive data on SL, thereby achieving power saving.
2. V2X: in R14/15, a scenario of vehicle-to-vehicle (V2V) communication is studied in an IoV system, which mainly aims at services of V2V communication and vehicle-to-person communication with relatively high-speed movement. In V2X, since a vehicle-mounted system has continuous power supply, power efficiency is not a key issue, but data transmission delay is a key issue, and thus a system design requires that a terminal device performs continuous transmission and reception.
3. Wearable device (further enhancement to device-to-device (FeD2D)): in R14, a scenario in which a wearable device accesses a network through a mobile phone is studied, which mainly aims at a scenario with low-speed movement and low-power access. In the FeD2D, in a pre-study stage, the 3GPP concludes that the base station can configure a discontinuous reception (DRX) parameter to a remote terminal via a relay terminal.

### II. Resource Selection Mode Applicable to New Radio (NR)-V2X, i.e., Mode 2

Based on mode 4 in the LTE-V2X, 3GPP re-discusses and designs a resource selection solution applicable to NR-V2X, which is recorded as mode 2. In mode 2, by decoding sidelink control information (SCI) sent by another terminal device and measuring SL received power, a terminal device may select, from a resource pool, a resource that is not reserved by another terminal device or a resource that is reserved by another terminal device but has relatively low receive power. A resource selection algorithm in NR-V2X mode 2 is divided into two main steps, that is, a terminal device firstly determines a set of candidate resources, and then selects a resource from the set of candidate resources to perform data transmission.
Step 1: the terminal device determines the set of candidate resources as follows. The terminal device takes all available resources in a resource selection window as a set A of resources. First, the terminal device needs to determine, according to a sensing result in a resource sensing window, whether a resource is reserved by another terminal device. The terminal device performs resource exclusion according to a slot not sensed and first-order SCI detected. After resource exclusion is completed, if the number of resources remaining in the set A of resources is less than a certain proportion, the terminal device increases a reference signal received power (RSRP) threshold by 3 dB, and repeatedly executes step 1 until the number of resources remaining in the set A of resources is greater than or equal to the proportion. Compared with LTE-V2X in which the proportion is fixed to 20%, in NR-V2X, a value of the proportion is more flexible, possible values of the proportion are {20, 35, 50} %, and a specific value of the proportion is pre-configured or configured by a network in units of a resource pool. Finally, the set A of resources subject to resource exclusion is the set of candidate resources for the terminal device.
Step 2: the terminal device selects a transmission resource from the set of candidate resources as follows. The terminal device randomly selects one or more transmission resources from the set A of resources with equal probability.

It may be noted that, when multiple transmission resources are to be selected, it is required to satisfy time-domain limitation that except some exceptional cases, a certain selected retransmission resource is able to be indicated by the first-order SCI sent previously. The exceptional cases above include that the terminal device after performing resource exclusion is unable to select a resource satisfying the time-domain limitation from the set A of resources. The exceptional cases above further include that the terminal device discards transmission due to factors such as resource preemption, congestion control, and collision with an uplink service, resulting in that a transmission resource for a certain retransmission is not indicated by the first-order SCI sent previously.

The terminal device may ensure that for any two selected time-frequency resources, if a previous transmission resource therein needs hybrid automatic repeat request (HARQ) feedback, the two resources are separated by at least a time length Z in the time domain. When resources selected cannot satisfy the time-domain limitation, for example, in the case that a packet delay budget (PDB) is relatively short but the number of retransmissions is relatively great, up to terminal device implementation, some selected retransmission resources may be discarded or HARQ feedback may be deactivated for the certain number of transmissions. III. Coordination mechanism between terminal devices

In mode 2, problems, such as excessive power consumption and relatively long transmission delay of a terminal device, are caused due to problems such as half-duplex, a hidden node, and resource collision. On this basis, a coordination mechanism between terminal devices is introduced in R17. The coordination mechanism mainly is that terminal A can send coordination information to terminal B, where the coordination information includes at least one of: a set of resources that terminal A expects the terminal B to use; a set of resources that terminal A does not expect the terminal B to use; or a set of resources with a resource conflict

After receiving the coordination information, terminal B may perform resource selection or resource reselection according to the coordination information. However, how to generate and send coordination information is not disclosed at present.

In order to solve the described technical problems, the disclosure provides a method for wireless communication.

It may be understood that the terminal device in embodiments of the disclosure may also be referred to as a user equipment (UE), an access terminal, a subscriber unit, a subscriber station, a mobile station, a mobile platform, a remote station, a remote terminal, a mobile device, a user terminal, a wireless communication device, a terminal, a user agent, a user apparatus, etc. The terminal device may be a station (ST) in a wireless local area network (WLAN), a cellular radio telephone, a cordless telephone, a session initiation protocol (SIP) telephone, a wireless local loop (WLL) station, a personal digital assistant (PDA). The terminal device may also be a device with wireless communication functions such as a handheld device, a computing device, other processing devices coupled with a wireless modem, an in-vehicle device, a wearable device, or a terminal in a next-generation communication system such as an NR network, a terminal in a future evolved public land mobile network (PLMN), etc.

As an example but not limitation, in embodiments of the disclosure, the terminal device may also be a wearable device. The wearable device can also be called a wearable smart device, which is a collective name of wearable devices intelligently designed and developed by applying a wearable technology to daily wear, such as glasses, gloves, watches, clothing, shoes, etc. The wearable device is a portable device that can be worn directly on the body or integrated into clothing or accessories of a user. The wearable device not only is a hardware device but also can realize powerful functions through software support, data interaction, and cloud interaction. Broadly speaking, the wearable smart device includes a device that has full functions and a large size and can realize all or part of functions without relying on a smart phone, e.g., a smart watch, smart glasses, or the like, and includes a device that only focuses on a certain application function and needs to be used with other devices such as a smart phone, e.g., all kinds of smart bracelets and smart jewelry for physical sign monitoring, or the like.

The network device may be a device that is used to communicate with a mobile device. The network device may be an access point (AP) in the WLAN, a base transceiver station (BTS) in a global system of mobile communication (GSM) or code division multiple access (CDMA) system, a NodeB (NB) in a wideband code division multiple access (WCDMA) system, or an evolved NodeB (eNB or eNodeB) in an LTE system. In an embodiment, the network device may also be a relay station, an AP, an in-vehicle device, a wearable device, a network device or a generation NodeB (gNB) in the NR network, a network device in the future evolved PLMN, etc.

It may be understood that embodiments of the disclosure are not only applicable to D2D, V2V, V2X, and other communication frames, but also applicable to any terminal-to-terminal communication frames, which is not limited herein. Embodiments of the disclosure are applied to an unlicensed spectrum, where the unlicensed spectrum can also be regarded as a shared spectrum.

It may be understood that, the “indication” referred to in embodiments of the disclosure may be a direct indication, an indirect indication, or an indication indicating an associated relation. For example, A indicates B, which can mean that A indicates B directly, e.g., B can be obtained through A, can also mean that A indicates B indirectly, e.g., A indicates C, and B can be obtained through C, or can further mean that A and B have an associated relation.

In illustration of embodiments of the disclosure, the term “correspondence” may represent a direct correspondence or indirect correspondence between the two, may also represent an associated relation between the two, or may further represent a relation of indicating and being indicated, a relation of configuring and being configured, or other relations.

The technical solutions of the disclosure are described in detail below.

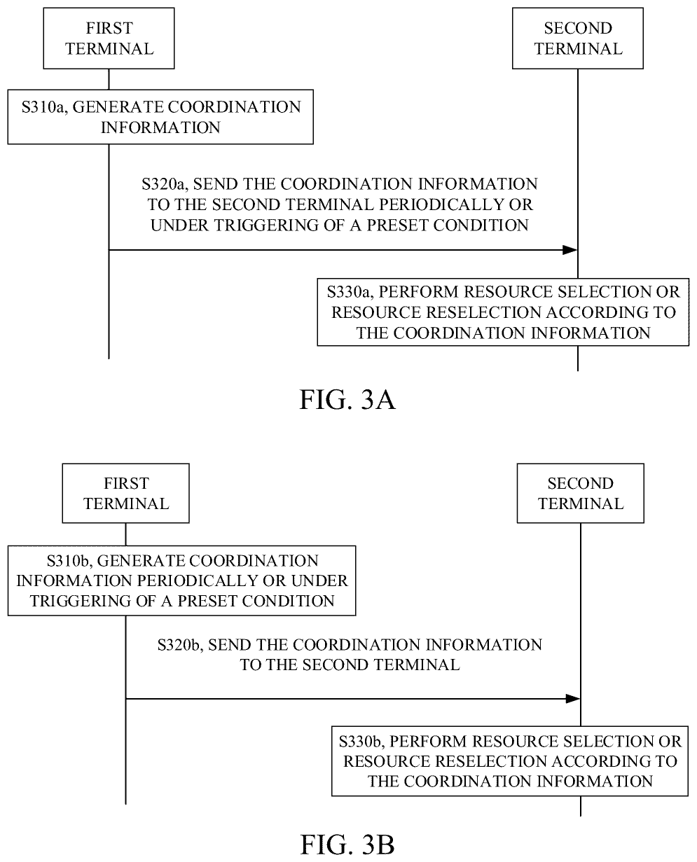

FIG. 3A is an interactive flowchart illustrating a method for wireless communication provided in embodiments of the disclosure. The method includes the following.
S310a, a first terminal generates coordination information.
S320a, the first terminal sends the coordination information to a second terminal periodically or under triggering of a preset condition.
S330a, the second terminal performs resource selection or resource reselection according to the coordination information.

FIG. 3B is an interactive flowchart illustrating another method for wireless communication provided in embodiments of the disclosure. The method includes the following.
S310b, a first terminal generates coordination information periodically or under triggering of a preset condition.
S320b, the first terminal sends the coordination information to a second terminal.
S330b, the second terminal performs resource selection or resource reselection according to the coordination information.

It may be understood that the coordination information is used for coordinating with the second terminal to perform resource selection or resource reselection.

In an embodiment, the coordination information includes at least one of: a set of resources that the first terminal expects the second terminal to use; a set of resources that the first terminal does not expect the second terminal to use; or a set of resources with a resource conflict, which is not limited herein.

In an embodiment, the coordination information includes an identifier (ID) of the second terminal, and/or, the coordination information is sent on a specific resource.

In an embodiment, the ID of the second terminal is any one of: an ID of the second terminal in a physical layer or a medium access control (MAC) layer, an ID of a terminal group to which the second terminal belongs, and an ID of a broadcast address in which the second terminal is interested, which is not limited herein.

It may be understood that when the coordination information includes the ID of the second terminal, after receiving the coordination information, the second terminal may determine, according to the ID, that the coordination information is sent to the second terminal. When the coordination information is sent on the specific resource, after receiving the coordination information, the second terminal may determine, according to the specific resource where the coordination information is located, that the coordination information is sent to the second terminal. When the coordination information includes the ID of the second terminal and the coordination information is sent on the specific resource, after receiving the coordination information, the second terminal may determine, according to the ID and the specific resource where the coordination information is located, that the coordination information is sent to the second terminal.

In an embodiment, the specific resource is a specific time-domain resource and/or a specific frequency-domain resource, which is not limited herein.

In an embodiment, the specific resource may be a resource negotiated and determined by the first terminal and the second terminal, or may be configured by a network device or predefined, which is not limited in the disclosure.

In an embodiment, the second terminal identifies, according to the ID of the second terminal and/or the specific resource on which the coordination information is sent, that the coordination information is sent to the second terminal. In addition to that, the second terminal may identify that the coordination information is sent to the second terminal, according to at least one of: the coordination information includes the ID of the second terminal; the coordination information is sent on the specific resource; a configuration corresponding to the coordination information matches a resource pool configuration of the second terminal; or the configuration corresponding to the coordination information matches a configuration corresponding to the request information, which is not limited herein.

In an embodiment, the case that the configuration corresponding to the coordination information matches the resource pool configuration of the second terminal includes, but is not limited to, that a time-domain resource and/or a frequency-domain resource for the coordination information are in a resource pool for the second terminal.

In an embodiment, the case that the configuration corresponding to the coordination information matches the configuration corresponding to the request information includes, but is not limited to, that a time-domain resource for the coordination information has a specific relationship with a time-domain resource for the request information, and/or that a frequency-domain resource for the coordination information has a specific relationship with a frequency-domain resource for the request information.

In an embodiment, the case that the time-domain resource for the coordination information has the specific relationship with the time-domain resource for the request information includes, but is not limited to, that the time-domain resource for the request information and the time-domain resource for the coordination information are separated by a preset duration.

In an embodiment, the case that the frequency-domain resource for the coordination information has the specific relationship with the frequency-domain resource for the request information includes, but is not limited to, that the frequency-domain resource for the request information is the same as the frequency-domain resource for the coordination information, or the frequency-domain resource for the request information and the frequency-domain resource for the coordination information are separated by a preset frequency band.

It may be understood that since the second terminal may perform data transmission many times, when data transmission is performed each time, the second terminal needs to select a resource for data to-be-sent this time. On this basis, the first terminal may send coordination information once for each resource selection, or send the coordination information once for multiple times of resource selection. For resource selection this time, the second terminal needs to determine whether coordination information received by the second terminal is used for resource selection or resource reselection this time.

In an embodiment, the second terminal identifies that the coordination information is for resource selection or resource reselection, according to at least one of: the coordination information is received within a third time period; a configuration corresponding to the coordination information matches a resource pool configuration of the second terminal; or the configuration corresponding to the coordination information matches a configuration corresponding to the request information, which is not limited herein.

In an embodiment, the third time period may be a fixed time period, or may also be a dynamically changed time period, which is not limited in the disclosure.

In an embodiment, the third time period is configured by the network device, configured by the first terminal, configured by the second terminal, or predefined, which is not limited herein.

In an embodiment, the third time period is a running duration of a second timer.

Exemplarily, assuming that the second timer is started at time a and stops running until the second timer expires, the running duration of the second timer is a duration from time a to a time when the second timer stops running.

In an embodiment, the second timer is configured by the network device, configured by the first terminal, configured by the second terminal, or predefined, which is not limited in the disclosure.

In an embodiment, when the first terminal periodically generates or sends the coordination information to the second terminal, a period of the coordination information may be configured by the network device, negotiated by the first terminal and the second terminal, or predefined, which is not limited in the disclosure.

In an embodiment, the foregoing preset condition includes, but is not limited to, any one of: the first terminal receives request information sent by the second terminal, where the request information is used for triggering the first terminal to send the coordination information to the second terminal; the first terminal is a receiving terminal for data to-be-sent of the second terminal, and a resource conflict exists between a resource reserved by the second terminal for the data to-be-sent and a resource for another terminal; the first terminal is the receiving terminal for the data to-be-sent of the second terminal, and the first terminal is unable to receive the data to-be-sent on at least one time-domain resource; and the first terminal is not the receiving terminal for the data to-be-sent of the second terminal, and a resource conflict exists between the resource reserved by the second terminal for the data to-be-sent and a resource for data transmission or data reception of the first terminal.

In an embodiment, when the second terminal sends the request information, the second terminal may send only the request information, or may send both the request information and second data to the first terminal.

In an embodiment, the second data may be any data that currently needs to be sent by the second terminal to the first terminal, which is not limited in the disclosure.

In an embodiment, the request information is sent by the second terminal to the first terminal according to a priority of the request information.

Exemplarily, assuming that the second terminal currently needs to send other data besides the request information, the other data does not include the second data. When the request information is information of the highest priority among all data or information to be sent by the second terminal, the second terminal may send the request information first. If the request information is not information of the highest priority among all the data or information to be sent by the second terminal, the second terminal may first send other data of a priority higher than a priority of the request information, and after these data is sent, the second terminal sends the request information.

In an embodiment, the priority of the request information is configured by the network or predefined, which is not limited in the disclosure.

Exemplarily, when the priority of the request information is configured by the network, in order to ensure that the request information may be preferentially sent to the first terminal, the network device may set the priority of the request information to be the highest priority. That is, the priority of the request information is higher than a priority of other data.

In an embodiment, the request information supports or does not support HARQ feedback.

It may be understood that, when the request information supports HARQ feedback, if the first terminal successfully receives the request information, the first terminal needs to send acknowledgement (ACK) to the second terminal; or if the first terminal does not successfully receive the request information, the first terminal needs to send negative acknowledgement (NACK) to the second terminal. On the contrary, when the request information does not support HARQ feedback, the first terminal does not need to send ACK or NACK to the second terminal.

In an embodiment, the request information is physical layer information, MAC layer information, or radio resource control (RRC) layer information, which is not limited herein.

In an embodiment, the request information may be existing signaling, such as RRC reconfiguration signaling, or the request information may be new signaling, which is not limited in the disclosure.

In an embodiment, in the case that the request information is the MAC layer information or the RRC layer information, an MAC protocol data unit (PDU) of the request information includes: an HARQ enable field or an HARQ disable field. The HARQ enable field indicates that the request information supports HARQ feedback, and the HARQ disable field indicates that the request information does not support HARQ feedback.

In an embodiment, the data to-be-sent of the second terminal refers to data to be sent on a resource selected by the second terminal this time.

In an embodiment, the case that a resource conflict exists between the resource reserved by the second terminal for the data to-be-sent and a resource for another terminal refers to that one or more resource conflicts exist between the resource reserved by the second terminal for the data to-be-sent and the resource for another terminal, or refers to that a relatively strong resource conflict exists between the resource reserved by the second terminal for the data to-be-sent and the resource for another terminal.

In an embodiment, the case that a resource conflict exists between the resource reserved by the second terminal for the data to-be-sent and the resource for another terminal refers to that the resource reserved by the second terminal for the data to-be-sent has been reserved by another terminal, or refers to that the resource reserved by the second terminal for the data to-be-sent has been reserved by another terminal device and has relatively high receive power.

In an embodiment, strength of the resource conflict may be measured by using a signal measurement result of the resource reserved by the second terminal for the data to-be-sent, and when the signal measurement result is greater than a preset threshold, it may be determined that the resource conflict is relatively strong.

In an embodiment, the case that the first terminal is unable to receive the data to-be-sent on at least one time-domain resource may be caused by a half-duplex problem of the first terminal and/or a DRX mechanism, which is not limited herein.

In an embodiment, the second terminal is in a DRX wake-up state within a second time period after the second terminal sends the request information.

In an embodiment, the second time period may be a fixed time period or a dynamically changed time period, which is not limited in the disclosure.

In an embodiment, the second time period is configured by the network device, configured by the first terminal, configured by the second terminal, or predefined, which is not limited herein.

In an embodiment, when the first terminal establishes a connection with the second terminal, the first terminal may be unable to receive the data to-be-sent on at least one time-domain resource due to a half-duplex problem of the first terminal and/or a DRX mechanism.

In an embodiment, when the first terminal has data that needs to be sent and has a higher priority than the data to-be-sent, the first terminal may be unable to receive the data to-be-sent on at least one time-domain resource due to a half-duplex problem of the first terminal.

In an embodiment, when the first terminal is configured with SL DRX, the first terminal may be unable to receive the data to-be-sent on at least one time-domain resource due to a DRX mechanism.

In an embodiment, the case that a resource conflict exists between the resource reserved by the second terminal for the data to-be-sent and a resource for data transmission or data reception of the first terminal refers to that one or more resource conflicts exist between the resource reserved by the second terminal for the data to-be-sent and a resource for data transmission or data reception of the first terminal, or refers to that a relatively strong resource conflict exists between the resource reserved by the second terminal for the data to-be-sent and a resource for data transmission or data reception of the first terminal.

In an embodiment, the case that a resource conflict exists between the resource reserved by the second terminal for the data to-be-sent and the resource for data transmission or data reception of the first terminal refers to that the resource reserved by the second terminal for the data to-be-sent has been reserved by the first terminal, or refers to that the resource reserved by the second terminal for the data to-be-sent has been reserved by the first terminal and has relatively high receive power.

In an embodiment, strength of the resource conflict may be measured by using a signal measurement result of the resource reserved by the second terminal for the data to-be-sent, and when the signal measurement result is greater than a preset threshold, it may be determined that the resource conflict is relatively strong.

In an embodiment, for any transmission process of the coordination information, the first terminal sends only the coordination information to the second terminal. In an embodiment, when first data is to be sent by the first terminal to the second terminal in a current transmission process, the first terminal sends both the coordination information and the first data to the second terminal.

It may be understood that, when the first terminal periodically sends the coordination information, any transmission process of the coordination information herein may be a periodical transmission process; or when the first terminal sends the coordination information under triggering of the preset condition, any transmission process of the coordination information herein may be a transmission process under triggering of the preset condition.

In an embodiment, the first data may be any data that the first terminal needs to send to the second terminal in the current transmission process of the coordination information, which is not limited in the disclosure.

In an embodiment, the first terminal sends the coordination information to the second terminal according to a priority of the coordination information.

Exemplarily, assuming that the first terminal currently needs to send other data besides the coordination information, the other data does not include the first data. When the coordination information is information of the highest priority among all data or information to be sent by the first terminal, the first terminal may send the coordination information first. If the coordination information is not information of the highest priority among all the data or information to be sent by the first terminal, the first terminal may first send other data of a priority higher than a priority of the coordination information, and after these data is sent, the first terminal sends the coordination information.

In an embodiment, the priority of the coordination information is configured by the network or predefined, which is not limited in the disclosure.

Exemplarily, when the priority of the coordination information is configured by the network, in order to ensure that the coordination information may be preferentially sent to the second terminal, the network device may set the priority of the coordination information to be the highest priority. That is, the priority of the coordination information is higher than a priority of other data.

In an embodiment, the first terminal needs to send the coordination information to the second terminal within a first time period.

In an embodiment, if the first terminal fails to send the coordination information to the second terminal within the first time period, the coordination information is discarded.

In an embodiment, if the first terminal sends the coordination information to the second terminal outside the first time period, the second terminal may discard the coordination information.

In an embodiment, the first time period may be a fixed time period or a dynamically changed time period, which is not limited in the disclosure.

In an embodiment, the first time period is configured by the network device, configured by the first terminal, configured by the second terminal, or predefined, which is not limited herein.

In an embodiment, the first time period is a running duration of a first timer.

Exemplarily, assuming that the first timer is started at time b and stops running until the first timer expires, the running duration of the first timer is a duration from time b to a time when the first timer stops running.

In an embodiment, the first timer is configured by the network device, configured by the first terminal, configured by the second terminal, or predefined, which is not limited herein.

In an embodiment, the coordination information supports or does not support HARQ feedback.

It may be understood that, when the coordination information supports HARQ feedback, if the second terminal successfully receives the coordination information, the second terminal needs to send ACK to the first terminal; or if the second terminal does not successfully receive the coordination information, the second terminal needs to send NACK to the first terminal. On the contrary, when the coordination information does not support HARQ feedback, the second terminal does not need to send ACK or NACK to the first terminal.

In an embodiment, the coordination information is MAC layer information and/or physical layer information, which is not limited herein.

In an embodiment, in the case that the coordination information is the MAC layer information or the RRC layer information, an MAC PDU of the coordination information includes: an HARQ enable field or an HARQ disable field. The HARQ enable field indicates that the coordination information supports HARQ feedback, and the HARQ disable field indicates that the coordination information does not support HARQ feedback.

In an embodiment, the coordination information is the MAC layer information in at least one of: a case that a resource pool configuration of the second terminal supports that the coordination information is the MAC layer information; a case that the first terminal and the second terminal negotiate and determine that the coordination information is the MAC layer information; a case that the coordination information is determined as the MAC layer information according to a correspondence between the coordination information and a service type; a case that the coordination information is determined as the MAC layer information according to a correspondence between the coordination information and a quality of service (QoS) flow; a case that the coordination information is determined as the MAC layer information according to a measurement result of a resource pool for the second terminal; a case that the coordination information is configured by a network as the MAC layer information; or a case that the coordination information is the MAC layer information by default, which is not limited herein.

In an embodiment, when the correspondence between the coordination information and the service type is a preset correspondence, the coordination information may be determined as the MAC layer information. The preset correspondence may be, but is not limited to, any one of: a one-to-one correspondence, a multiple-to-one correspondence, and a one-to-multiple correspondence.

Exemplarily, assuming that a purpose of resource selection performed by the second terminal according to the coordination information is to deal with a service of a certain service type, a correspondence between the service type and the coordination information is a one-to-one correspondence, and the preset correspondence above is also a one-to-one correspondence, and thus the coordination information may be determined as the MAC layer information.

In an embodiment, when the correspondence between the coordination information and the QoS flow is a preset correspondence, the coordination information may be determined as the MAC layer information. The preset correspondence may be, but is not limited to, any one of: a one-to-one correspondence, a multiple-to-one correspondence, and a one-to-multiple correspondence.

Exemplarily, assuming that a purpose of resource selection performed by the second terminal according to the coordination information is to deal with at least one QoS flow of a certain service and assuming that a correspondence between each QoS flow among the at least one QoS flow and the coordination information is a one-to-one correspondence, and the preset correspondence above is also a one-to-one correspondence, and thus the coordination information may be determined as the MAC layer information.

In an embodiment, in the case that the coordination information is the MAC information, after the second terminal receives the coordination information sent by the first terminal, the method further includes the following. An MAC layer of the second terminal sends indication information to a physical layer of the second terminal. The indication information indicates the physical layer to perform resource selection.

It may be understood that, in the resource selection process of the second terminal in mode 2, the physical layer of the second terminal is used for determining a set of candidate resources, and the MAC layer of the second terminal is used for selecting a transmission resource from the set of candidate resources. Based on this, after the MAC layer of the second terminal receives the coordination information, the physical layer may be triggered to perform resource exclusion for the data to-be-sent. In the same case, the physical layer is informed of decoded coordination information, and the physical layer performs resource exclusion according to the above information and reports a set of available resources to the MAC layer. The MAC layer selects a resource from the set of available resources according to the coordination information.

In an embodiment, the indication information further indicates to the physical layer a parameter related to resource selection, and/or information related to the coordination information obtained after the MAC layer decodes the coordination information.

In an embodiment, the coordination information is the physical layer information in at least one of: a case that a resource pool configuration of the second terminal supports that the coordination information is the physical layer information; a case that the first terminal and the second terminal negotiate and determine that the coordination information is the physical layer information; a case that the coordination information is determined as the physical layer information according to a correspondence between the coordination information and a service type; a case that the coordination information is determined as the physical layer information according to a correspondence between the coordination information and a QoS flow; a case that the coordination information is determined as the physical layer information according to a measurement result of a resource pool for the second terminal; a case that the coordination information is configured by a network as the physical layer information; or a case that the coordination information is the physical layer information by default, which is not limited herein.

In an embodiment, when the correspondence between the coordination information and the service type is a preset correspondence, the coordination information may be determined as the physical layer information. The preset correspondence may be, but is not limited to, any one of: a one-to-one correspondence, a multiple-to-one correspondence, and a one-to-multiple correspondence.

Exemplarily, assuming that a purpose of resource selection performed by the second terminal according to the coordination information is to deal with a service of a certain service type, a correspondence between the service type and the coordination information is a multiple-to-one correspondence, and the preset correspondence above is also a multiple-to-one correspondence, and thus the coordination information may be determined as the physical layer information.

In an embodiment, when the correspondence between the coordination information and the QoS flow is a preset correspondence, the coordination information may be determined as the physical layer information. The preset correspondence may be, but is not limited to, any one of: a one-to-one correspondence, a multiple-to-one correspondence, and a one-to-multiple correspondence.

Exemplarily, assuming that a purpose of resource selection performed by the second terminal according to the coordination information is to deal with at least one QoS flow of a certain service and assuming that a correspondence between each QoS flow among the at least one QoS flow and the coordination information is a multiple-to-one correspondence, and the preset correspondence above is also a multiple-to-one correspondence, and thus the coordination information may be determined as the physical layer information.

In an embodiment, in the case that the coordination information is the physical layer information, before the second terminal receives the coordination information sent by the first terminal periodically or under triggering of the preset condition, the method further includes the following. The MAC layer of the second terminal sends the indication information to the physical layer of the second terminal. The indication information indicates the physical layer to perform resource selection.

It may be understood that, in the resource selection process of the second terminal in mode 2, the physical layer of the second terminal is used for determining a set of candidate resources, and the MAC layer of the second terminal is used for selecting a transmission resource from the set of candidate resources. Based on this, after the MAC layer of the second terminal receives the coordination information, the physical layer may be triggered via the indication information to perform resource exclusion for the data to-be-sent. After the physical layer receives the coordination information, the physical layer decodes the coordination information, performs resource exclusion according to the above information, and reports a set of available resources to the MAC layer. The MAC layer selects a resource from the set of available resources.

In an embodiment, the indication information further indicates to the physical layer a parameter related to resource selection, and/or information related to the coordination information obtained after the MAC layer decodes the coordination information.

In an embodiment, the second terminal performs resource selection or resource reselection according to the coordination information as follows. The second terminal selects the set of resources that the first terminal expects the second terminal to use; and/or the second terminal excludes the set of resources that the first terminal does not expect the second terminal to use; and/or the second terminal excludes the set of resources with the resource conflict.

Exemplarily, assuming that the coordination information includes a set A of resources that the first terminal expects the second terminal to use, the second terminal may directly select the set A of resources or preferentially select the set A of resources. The second terminal selects, in combination with existing mode 2, a resource required for the data to-be-sent.

Exemplarily, assuming that the coordination information includes a set B of resources that the first terminal does not expect the second terminal to use, when the second terminal performs resource selection in existing mode 2, the second terminal may exclude the set B of resources. Furthermore, the second terminal selects, in combination with existing mode 2, a resource required for the data to-be-sent.

Exemplarily, assuming that the coordination information includes a set C of resources with the resource conflict, when the second terminal performs resource selection in existing mode 2, the second terminal may exclude the set C of resources. Furthermore, the second terminal selects, in combination with existing mode 2, a resource required by the data to-be-sent.

In an embodiment, the second terminal performs resource selection or resource reselection according to the coordination information as follows. The second terminal preferentially selects the set of resources that the first terminal expects the second terminal to use; and/or the second terminal excludes the set of resources that the first terminal does not expect the second terminal to use; and/or the second terminal excludes the set of resources with the resource conflict.

Exemplarily, assuming that the coordination information includes a set A of resources that the first terminal expects the second terminal to use, the second terminal may select, according to existing mode 2, a set of resources required for the data to-be-sent. If multiple sets of candidate resources exist and include the set A of resources, the second terminal may preferentially select the set A of resources and select a required resource from the set A of resources.

In conclusion, in the disclosure, the first terminal generates coordination information, and the first terminal sends the coordination information to the second terminal periodically or under triggering of a preset condition; or the first terminal generates the coordination information periodically or under triggering of the preset condition, and the first terminal sends the coordination information to the second terminal. The second terminal performs resource selection or resource reselection according to the coordination information. Therefore, a generation mode and a transmission mode of the coordination information are proposed for the first time. Furthermore, the disclosure further provides information in the coordination information, whether the coordination information supports HARQ feedback, whether the coordination information is MAC layer information and/or physical layer information, etc. Furthermore, the disclosure further provides information in request information, whether the request information supports HARQ feedback, whether the request information is MAC layer information or physical layer information, etc.

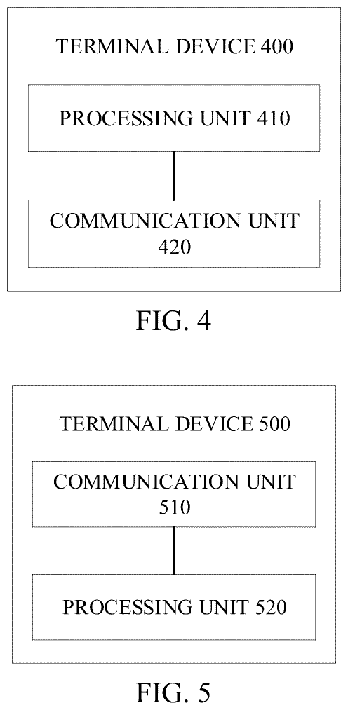

FIG. 4 is a schematic block diagram illustrating a terminal device 400 according to embodiments of the disclosure. The terminal device 400 is the first terminal above and includes a processing unit 410 and a communication unit 420. The processing unit 410 is configured to generate coordination information. The communication unit 420 is configured to send the coordination information to a second terminal. The coordination information is used for coordinating with the second terminal to perform resource selection or resource reselection. The coordination information is generated periodically or under triggering of a preset condition, or the coordination information is sent periodically or under triggering of the preset condition.

In an embodiment, the communication unit 420 is specifically configured to: send only the coordination information to the second terminal; or send both the coordination information and first data to the second terminal in the case that there currently exists the first data to be sent by the first terminal to the second terminal.

In an embodiment, the communication unit 420 is specifically configured to send the coordination information to the second terminal according to a priority of the coordination information.

In an embodiment, the priority of the coordination information is configured by a network or predefined.

In an embodiment, the communication unit 420 is specifically configured to send the coordination information to the second terminal within a first time period.

In an embodiment, the first time period is configured by a network device, configured by the first terminal, configured by the second terminal, or predefined.

In an embodiment, the first time period is a running duration of a first timer.

In an embodiment, the first timer is configured by a network device, configured by the first terminal, configured by the second terminal, or predefined.

In an embodiment, the coordination information supports or does not support HARQ feedback.

In an embodiment, the coordination information is MAC layer information and/or physical layer information.

In an embodiment, in the case that the coordination information is the MAC information, an MAC PDU of the coordination information includes an HARQ enable field or an HARQ disable field. The HARQ enable field indicates that the coordination information supports HARQ feedback, and the HARQ disable field indicates that the coordination information does not support HARQ feedback.

In an embodiment, the coordination information is the MAC layer information in at least one of: a case that a resource pool configuration of the second terminal supports that the coordination information is the MAC layer information; a case that the first terminal and the second terminal negotiate and determine that the coordination information is the MAC layer information; a case that the coordination information is determined as the MAC layer information according to a correspondence between the coordination information and a service type; a case that the coordination information is determined as the MAC layer information according to a correspondence between the coordination information and a QoS flow; a case that the coordination information is determined as the MAC layer information according to a measurement result of a resource pool for the second terminal; a case that the coordination information is configured by a network as the MAC layer information; or a case that the coordination information is the MAC layer information by default.

In an embodiment, the coordination information is the physical layer information in at least one of: a case that a resource pool configuration of the second terminal supports that the coordination information is the physical layer information; a case that the first terminal and the second terminal negotiate and determine that the coordination information is the physical layer information; a case that the coordination information is determined as the physical layer information according to a correspondence between the coordination information and a service type; a case that the coordination information is determined as the physical layer information according to a correspondence between the coordination information and a QoS flow; a case that the coordination information is determined as the physical layer information according to a measurement result of a resource pool for the second terminal; a case that the coordination information is configured by a network as the physical layer information; or a case that the coordination information is the physical layer information by default.

In an embodiment, the coordination information includes at least one of: a set of resources that the first terminal expects the second terminal to use; a set of resources that the first terminal does not expect the second terminal to use; or a set of resources with a resource conflict.

In an embodiment, the coordination information includes an ID of the second terminal, and/or, the coordination information is sent on a specific resource.

In an embodiment, the ID of the second terminal is an ID of the second terminal in a physical layer or an MAC layer.

In an embodiment, the specific resource is a specific time-domain resource and/or a specific frequency-domain resource.

In an embodiment, the preset condition includes any one of: the first terminal receives request information sent by the second terminal, where the request information is used for triggering the first terminal to send the coordination information to the second terminal; the first terminal is a receiving terminal for data to-be-sent of the second terminal, and a resource conflict exists between a resource reserved by the second terminal for the data to-be-sent and a resource for another terminal; the first terminal is the receiving terminal for the data to-be-sent of the second terminal, and the first terminal is unable to receive the data to-be-sent on at least one time-domain resource; and the first terminal is not the receiving terminal for the data to-be-sent of the second terminal, and a resource conflict exists between the resource reserved by the second terminal for the data to-be-sent and a resource for data transmission or data reception of the first terminal.

In an embodiment, the request information is sent separately by the second terminal to the first terminal, or both the request information and second data are sent by the second terminal to the first terminal.

In an embodiment, the request information is sent by the second terminal to the first terminal according to a priority of the request information.

In an embodiment, the priority of the request information is configured by a network or predefined.

In an embodiment, the request information supports or does not support HARQ feedback.

In an embodiment, the request information is physical layer information, MAC layer information, or RRC layer information.

In an embodiment, in the case that the request information is the MAC layer information or the RRC layer information, an MAC PDU of the request information includes: an HARQ enable field or an HARQ disable field. The HARQ enable field indicates that the request information supports HARQ feedback, and the HARQ disable field indicates that the request information does not support HARQ feedback.

In an embodiment, the second terminal is in a DRX wake-up state within a second time period after the second terminal sends the request information.

In an embodiment, in some embodiments, the communication unit above may be a communication interface or a transceiver, or an input/output interface of a communication chip or a system on a chip. The processing unit above may be one or more processors.

It may be understood that, according to embodiments of the disclosure, the terminal device 400 can correspond to the first terminal above, and the above-mentioned and other operations and/or functions of each unit in the terminal device 400 respectively implement a corresponding process performed by the first terminal, which will not be repeated herein for the sake of simplicity.

FIG. 5 is a schematic block diagram illustrating a terminal device 500 according to embodiments of the disclosure. The terminal device 500 is the second terminal above and includes a communication unit 510 and a processing unit 520. The communication unit 510 is configured to receive coordination information sent by a first terminal. The processing unit 520 is configured to perform resource selection or resource reselection according to the coordination information. The coordination information is generated periodically or under triggering of a preset condition, or the coordination information is sent periodically or under triggering of the preset condition.

In an embodiment, the preset condition includes any one of: the first terminal receives request information sent by the second terminal, where the request information is used for triggering the first terminal to send the coordination information to the second terminal; the first terminal is a receiving terminal for data to-be-sent of the second terminal, and a resource conflict exists between a resource reserved by the second terminal for the data to-be-sent and a resource for another terminal; the first terminal is the receiving terminal for the data to-be-sent of the second terminal, and the first terminal is unable to receive the data to-be-sent on at least one time-domain resource; and the first terminal is not the receiving terminal for the data to-be-sent of the second terminal, and a resource conflict exists between the resource reserved by the second terminal for the data to-be-sent and a resource for data transmission or data reception of the first terminal.

In an embodiment, the communication unit 510 is further configured to send only the request information to the first terminal or send both the request information and second data to the first terminal, before receiving the coordination information sent by the first terminal.

In an embodiment, the request information is sent by the second terminal to the first terminal according to a priority of the request information.

In an embodiment, the priority of the request information is configured by a network or predefined.

In an embodiment, the request information supports or does not support HARQ feedback.

In an embodiment, the request information is physical layer information, MAC layer information, or RRC layer information.

In an embodiment, in the case that the request information is the MAC layer information or the RRC layer information, an MAC PDU of the request information includes: an HARQ enable field or an HARQ disable field. The HARQ enable field indicates that the request information supports HARQ feedback, and the HARQ disable field indicates that the request information does not support HARQ feedback.

In an embodiment, the coordination information includes an ID of the second terminal, and/or, that the coordination information is sent on a specific resource.

In an embodiment, the processing unit 520 is further configured to identify that the coordination information is sent to the second terminal, according to at least one of: the coordination information includes the ID of the second terminal; the coordination information is sent on the specific resource; a configuration corresponding to the coordination information matches a resource pool configuration of the second terminal; or the configuration corresponding to the coordination information matches a configuration corresponding to the request information.

In an embodiment, the ID of the second terminal is an ID of the second terminal in a physical layer or an MAC layer.

In an embodiment, the specific resource is a specific time-domain resource and/or a specific frequency-domain resource.

In an embodiment, the processing unit 520 is further configured to identify that the coordination information is for resource selection or resource reselection, according to at least one of: the coordination information is received within a third time period; a configuration corresponding to the coordination information matches a resource pool configuration of the second terminal; or the configuration corresponding to the coordination information matches a configuration corresponding to the request information.

In an embodiment, the third time period is configured by a network device, configured by the first terminal, configured by the second terminal, or predefined.

In an embodiment, the third time period is a running duration of a second timer.

In an embodiment, the second timer is configured by a network device, by the first terminal, by the second terminal, or predefined.

In an embodiment, the second terminal is in a DRX wake-up state within a second time period after the second terminal sends the request information.

In an embodiment, the coordination information is sent separately by the first terminal to the second terminal; or in the case that there currently exists first data to be sent by the first terminal to the second terminal, both the coordination information and the first data are sent by the first terminal to the second terminal.

In an embodiment, the coordination information is sent by the first terminal to the second terminal according to a priority of the coordination information.

In an embodiment, the priority of the coordination information is configured by a network or predefined.

In an embodiment, the coordination information is sent within a first time period.

In an embodiment, the first time period is configured by a network device, configured by the first terminal, configured by the second terminal, or predefined.

In an embodiment, the first time period is a running duration of a first timer.

In an embodiment, the first timer is configured by a network device, configured by the first terminal, configured by the second terminal, or predefined.

In an embodiment, the coordination information supports or does not support HARQ feedback.

In an embodiment, the coordination information is MAC layer information and/or physical layer information.

In an embodiment, in the case that the coordination information is the MAC information, an MAC PDU of the coordination information includes an HARQ enable field or an HARQ disable field. The HARQ enable field indicates that the coordination information supports HARQ feedback, and the HARQ disable field indicates that the coordination information does not support HARQ feedback.

In an embodiment, the coordination information is the MAC layer information in at least one of: a case that a resource pool configuration of the second terminal supports that the coordination information is the MAC layer information; a case that the first terminal and the second terminal negotiate and determine that the coordination information is the MAC layer information; a case that the coordination information is determined as the MAC layer information according to a correspondence between the coordination information and a service type; a case that the coordination information is determined as the MAC layer information according to a correspondence between the coordination information and a QoS flow; a case that the coordination information is determined as the MAC layer information according to a measurement result of a resource pool for the second terminal; a case that the coordination information is configured by a network as the MAC layer information; or a case that the coordination information is the MAC layer information by default.

In an embodiment, the processing unit 520 is further configured to send indication information to a physical layer through an MAC layer, after the communication unit 510 receives the coordination information sent by the first terminal, in the case that the coordination information is the MAC information. The indication information indicates the physical layer to perform resource selection or resource reselection.

In an embodiment, the coordination information is the physical layer information in at least one of: a case that a resource pool configuration of the second terminal supports that the coordination information is the physical layer information; a case that the first terminal and the second terminal negotiate and determine that the coordination information is the physical layer information; a case that the coordination information is determined as the physical layer information according to a correspondence between the coordination information and a service type; a case that the coordination information is determined as the physical layer information according to a correspondence between the coordination information and a QoS flow; a case that the coordination information is determined as the physical layer information according to a measurement result of a resource pool for the second terminal; a case that the coordination information is configured by a network as the physical layer information; or a case that the coordination information is the physical layer information by default.

In an embodiment, the processing unit 520 is further configured to send indication information to a physical layer through an MAC layer, before the communication unit 510 receives the coordination information sent by the first terminal, in the case that the coordination information is the physical layer information. The indication information indicates the physical layer to perform resource selection or resource reselection.

In an embodiment, the indication information further indicates to the physical layer a parameter related to resource selection, and/or information related to the coordination information obtained after the MAC layer decodes the coordination information.

In an embodiment, the coordination information includes at least one of: a set of resources that the first terminal expects the second terminal to use; a set of resources that the first terminal does not expect the second terminal to use; or a set of resources with a resource conflict.

In an embodiment, the processing unit 520 is specifically configured to: select the set of resources that the first terminal expects the second terminal to use; and/or exclude the set of resources that the first terminal does not expect the second terminal to use; and/or exclude the set of resources with the resource conflict.

In an embodiment, the processing unit 520 is specifically configured to: preferentially select the set of resources that the first terminal expects the second terminal to use; and/or exclude the set of resources that the first terminal does not expect the second terminal to use; and/or exclude the set of resources with the resource conflict.

In an embodiment, in some embodiments, the communication unit above may be a communication interface or a transceiver, or an input/output interface of a communication chip or a system on a chip. The processing unit above may be one or more processors.

It may be understood that, according to embodiments of the disclosure, the terminal device 500 can correspond to the second terminal above, and the above-mentioned and other operations and/or functions of each unit in the terminal device 500 respectively implement a corresponding process performed by the second terminal, which will not be repeated herein for the sake of simplicity.

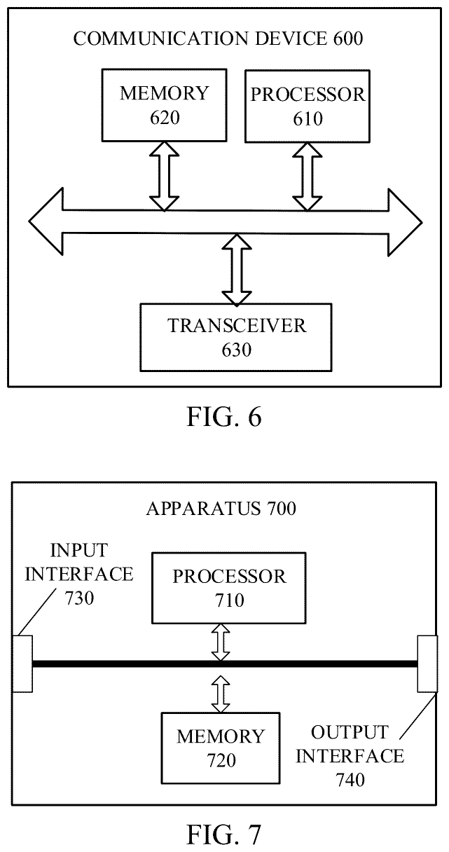

FIG. 6 is a schematic structural diagram illustrating a communication device 600 provided in embodiments of the disclosure. As illustrated in FIG. 6, the communication device 600 includes a processor 610. The processor 610 is configured to invoke and execute computer programs stored in a memory, to implement the method in embodiments of the disclosure.

In an embodiment, as illustrated in FIG. 6, the communication device 600 may further include a memory 620. The processor 610 is configured to invoke and execute computer programs stored in the memory 620 to implement the method in embodiments of the disclosure.

The memory 620 may be a separate device independent of the processor 610, or may be integrated into the processor 610.

In an embodiment, as illustrated in FIG. 6, the communication device 600 may further include a transceiver 630. The processor 610 can control the transceiver 630 to communicate with other devices, specifically, to send information or data to other devices, or receive information or data from other devices.

The transceiver 630 may include a transmitter and a receiver. The transceiver 630 may further include one or more antennas.

In an embodiment, the communication device 600 may be implemented as the first terminal in embodiments of the disclosure, and the communication device 600 can implement the corresponding processes performed by the first terminal described in the method in embodiments of the disclosure, which will not be repeated herein for the sake of simplicity.

In an embodiment, the communication device 600 may be implemented as the second terminal in embodiments of the disclosure, and the communication device 600 can implement the corresponding processes performed by the second terminal described in the method in embodiments of the disclosure, which will not be repeated herein for the sake of simplicity.

FIG. 7 is a schematic structural diagram illustrating an apparatus 700 provided in embodiments of the disclosure. As illustrated in FIG. 7, the apparatus 700 includes a processor 710. The processor 710 is configured to invoke and execute computer programs stored in a memory to implement the method in embodiments of the disclosure.

In an embodiment, as illustrated in FIG. 7, the apparatus 700 may further include a memory 720. The processor 710 is configured to invoke and execute computer programs stored in the memory 720 to implement the method in embodiments of the disclosure.

The memory 720 may be a separate device independent of the processor 710, or may be integrated into the processor 710.

In an embodiment, the apparatus 700 may further include an input interface 730. The processor 710 can control the input interface 730 to communicate with other devices or chips, specifically, to obtain information or data sent by other devices or chips.

In an embodiment, the apparatus 700 may further include an output interface 740. The processor 710 can control the output interface 740 to communicate with other devices or chips, specifically, to output information or data to other devices or chips.

In an embodiment, the apparatus is applicable to the first terminal in embodiments of the disclosure and can implement the corresponding processes performed by the first terminal described in the method in embodiments of the disclosure, which will not be repeated herein for the sake of simplicity.

In an embodiment, the apparatus is applicable to the second terminal in embodiments of the disclosure and can implement the corresponding processes performed by the second terminal described in the method in embodiments of the disclosure, which will not be repeated herein for the sake of simplicity.

In an embodiment, the apparatus involved in embodiments of the disclosure may also be a chip, such as a system-level chip, a system chip, a chip system, a system-on-a-chip chip, etc.

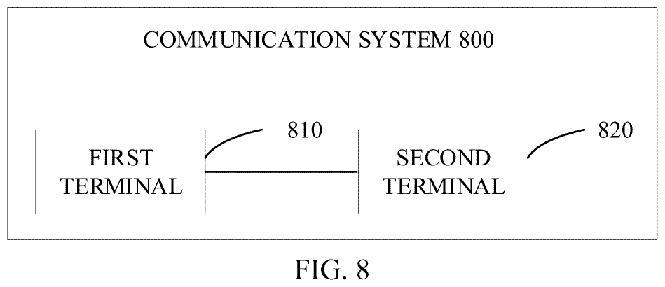

FIG. 8 is a schematic block diagram illustrating a communication system 800 provided in embodiments of the disclosure. As illustrated in FIG. 8, the communication system 800 includes a first terminal 810 and a second terminal 820.

The first terminal 810 can be configured to implement the corresponding functions implemented by the terminal device in the above method, and the second terminal 820 can be configured to implement the corresponding functions implemented by the network device or the base station in the above method, which are not repeated herein.

It may be understood that the processor in embodiments of the disclosure may be an integrated circuit chip with signal processing capabilities. During implementation, each step of the foregoing method embodiments may be completed by an integrated logic circuit of hardware in the processor or an instruction in the form of software. The processor above may be a general-purpose processor, a digital signal processor (DSP), an application specific integrated circuit (ASIC), a field programmable gate array (FPGA), other programmable logic devices, discrete gates or transistor logic devices, or discrete hardware components. The methods, steps, and logic block diagrams disclosed in embodiments can be implemented or executed. The general-purpose processor may be a microprocessor, or the processor may be any conventional processor or the like. The steps of the method disclosed in embodiments of the disclosure may be directly implemented as a hardware decoding processor, or may be performed by hardware and software modules in the decoding processor. The software module can be located in a storage medium such as a random access memory (RAM), a flash memory, a read-only memory (ROM), a programmable ROM (PROM), or an electrically erasable programmable memory, a register, and the like. The storage medium is located in the memory. The processor reads information in the memory, and completes the steps of the method described above with the hardware thereof.

It may be understood that the memory in embodiments of the disclosure may be a volatile memory or a non-volatile memory, or may include both the volatile memory and the non-volatile memory. The non-volatile memory may be an ROM, a PROM, an erasable PROM (EPROM), an electrically EPROM (EEPROM), or a flash memory. The volatile memory can be an RAM that acts as an external cache. By way of example but not limitation, many forms of RAM are available, such as a static random access memory (SRAM), a dynamic random access memory (DRAM), a synchronous dynamic random access memory (SDRAM), an enhanced SDRAM (ESDRAM), a synclink dynamic random access memory (SLDRAM), and a direct rambus random access memory (DRRAM). It may be noted that the memory in the system and the method described herein is intended to include, but is not limited to, these and any other suitable types of memory.

It may be understood that the memory above is illustrated as an example rather than a limitation. For example, the memory in embodiments of the disclosure may also be an SRAM, a DRAM, an SDRAM, a DDR SDRAM, an ESDRAM, an SLDRAM, a DRRAM, etc. That is, the memory in embodiments of the disclosure is intended to include, but is not limited to, these and any other suitable types of memory.

A non-transitory computer-readable storage medium is further provided in embodiments of the disclosure. The non-transitory computer-readable storage medium is configured to store computer programs.

In an embodiment, the non-transitory computer-readable storage medium is applicable to the network device or the base station in embodiments of the disclosure, and the computer programs enable a computer to perform the corresponding processes implemented by the network device or the base station in the method in embodiments of the disclosure, which is not repeated herein for the sake of simplicity.

In an embodiment, the non-transitory computer-readable storage medium is applicable to the mobile terminal/terminal device in embodiments of the disclosure, and the computer programs enable a computer to perform the corresponding processes implemented by the mobile terminal/terminal device in the method in embodiments of the disclosure, which is not repeated herein for the sake of simplicity.

A computer program product is further provided in embodiments of the disclosure. The computer program product includes computer program instructions.

In an embodiment, the computer program product is applicable to the network device or the base station in embodiments of the disclosure, and the computer program instructions enable a computer to perform the corresponding processes implemented by the network device or the base station in the method in embodiments of the disclosure, which is not repeated herein for the sake of simplicity.

In an embodiment, the computer program product is applicable to the mobile terminal/terminal device in embodiments of the disclosure, and the computer program instructions enable a computer to perform the corresponding processes implemented by the mobile terminal/terminal device in the method in embodiments of the disclosure, which is not repeated herein for the sake of simplicity.

A computer program is further provided in embodiments of the disclosure.

In an embodiment, the computer program is applicable to the network device or the base station in embodiments of the disclosure. The computer program, when run on a computer, enables the computer to perform the corresponding processes implemented by the network device or the base station in the method in embodiments of the disclosure, which is not repeated herein for the sake of simplicity.

In an embodiment, the computer program product is applicable to the mobile terminal/terminal device in embodiments of the disclosure. The computer program, when run on a computer, enables the computer to perform the corresponding processes implemented by the mobile terminal/terminal device in the method in embodiments of the disclosure, which is not repeated herein for the sake of simplicity.

Those of ordinary skill in the art will appreciate that units and algorithmic operations of various examples described in connection with embodiments herein can be implemented by electronic hardware or by a combination of computer software and electronic hardware. Whether these functions are performed by means of hardware or software depends on the specific application and the design constraints of the technical solution. Those skilled in the art may use different methods with regard to each particular application to implement the described functions, but such implementation may not be regarded as lying beyond the scope of the disclosure.

It will be evident to those skilled in the art that, for the sake of convenience and simplicity, in terms of the specific working processes of the foregoing systems, apparatuses, and units, reference can be made to the corresponding processes of the above method embodiments, which will not be repeated herein.

It will be appreciated that the systems, apparatuses, and methods disclosed in several embodiments herein may also be implemented in various other manners. For example, the above apparatus embodiments are merely illustrative, e.g., the division of units is only a division of logical functions, and there may exist other manners of division in practice, e.g., multiple units or assemblies may be combined or may be integrated into another system, or some features may be ignored or skipped. In other respects, the coupling or direct coupling or communication connection as illustrated or discussed may be an indirect coupling or communication connection through some interfaces, apparatuses, or units, and may be electrical, mechanical, or otherwise. Separated units as illustrated may or may not be physically separated. Components displayed as units may or may not be physical units, i.e., may reside at one location or may be distributed to multiple network units. Some or all of the units may be selected or reselected according to practical needs to achieve objectives of the solutions of embodiments.

In addition, various functional units described in embodiments herein may be integrated into one processing unit or may be present as a number of physically separated units, or two or more units may be integrated into one unit.

If the functions are implemented as software functional units and sold or used as standalone products, they may be stored in a non-transitory computer-readable storage medium. Based on such an understanding, the essential technical solution, or the portion that contributes to the prior art, or part of the technical solutions of the disclosure may be embodied as software products. The computer software products are stored in a storage medium and include multiple instructions that enable a computing device (e.g., a personal computer, a server, a network device, etc.) to execute some or all operations of the methods described in various embodiments of the disclosure. The above storage medium includes various kinds of media that can store program codes, such as a universal serial bus (USB) flash disk, a mobile hard drive, an ROM, an RAM, a magnetic disk, or an optical disk.

The above are merely specific embodiments of the disclosure and are not intended to limit the scope of protection of the disclosure. Any modification and replacement easily made by those skilled in the art within the technical scope of the disclosure shall be included in the scope of protection of the disclosure. Therefore, the scope of protection of the disclosure may be stated in the scope of protection of the claims.

What is claimed is:

1. A method for wireless communication, comprising:
generating, by a first terminal, coordination information; and
sending, by the first terminal, the coordination information to a second terminal;
wherein the coordination information is used for coordinating with the second terminal to perform resource selection or resource reselection, and the coordination information is generated under triggering of a preset condition, or the coordination information is sent under triggering of the preset condition.

2. The method of claim 1, wherein sending, by the first terminal, the coordination information to the second terminal, comprises:
sending, by the first terminal, the coordination information to the second terminal according to a priority of the coordination information.

3. The method of claim 1, wherein sending, by the first terminal, the coordination information to the second terminal according to a priority of the coordination information, comprises:
in a case that there exists other data besides the coordination information to be sent from the first terminal to the second terminal,
sending, by the first terminal, the coordination information and sending, by the first terminal, the other data after sending the coordination information, in response to the coordination information being of highest priority among all data to be sent by the first terminal; or
sending, by the first terminal, data of a higher priority than the coordination information and sending the coordination information after sending the data of the higher priority than the coordination information, in response to the coordination information being not of the highest priority among all data to be sent by the first terminal.

4. The method of claim 2, wherein the priority of the coordination information is predefined.

5. The method of claim 1, wherein sending, by the first terminal, the coordination information to the second terminal, comprises:
sending, by the first terminal, the coordination information to the second terminal within a first time period, wherein the first time period is a running duration of a first timer.

6. The method of claim 5, wherein the first timer is configured by the second terminal.

7. The method of claim 1, wherein the coordination information is medium access control (MAC) layer information and/or physical layer information.

8. The method of claim 7, wherein the coordination information is the MAC layer information by default.

9. The method of claim 7, wherein the coordination information is the physical layer information in a case that a resource pool configuration of the second terminal supports that the coordination information is the physical layer information.

10. The method of claim 1, wherein the coordination information comprises at least one of:
a set of resources for the second terminal to use; or
a set of resources not for the second terminal to use.

11. The method of claim 1, wherein the preset condition comprises any one of:
the first terminal receives request information sent by the second terminal, wherein the request information is used for triggering the first terminal to send the coordination information to the second terminal; and
the first terminal is the receiving terminal for the data to-be-sent of the second terminal, and the first terminal is unable to receive the data to-be-sent on at least one time-domain resource.

12. The method of claim 11, wherein the request information is physical layer information, and/or MAC layer information.

13. A terminal device, comprising:
a processor and a memory, the memory being configured to store computer programs, and the processor being configured to execute the computer programs stored in the memory to:
receive coordination information sent by a first terminal; and
perform resource selection or resource reselection according to the coordination information;
wherein the coordination information is generated under triggering of a preset condition, or the coordination information is sent under triggering of the preset condition.

14. The terminal device of claim 13, wherein the preset condition comprises any one of:
the first terminal receives request information sent by the second terminal, wherein the request information is used for triggering the first terminal to send the coordination information to the second terminal; and
the first terminal is the receiving terminal for the data to-be-sent of the second terminal, and the first terminal is unable to receive the data to-be-sent on at least one time-domain resource.

15. The terminal device of claim 14, wherein the request information is sent by the second terminal to the first terminal according to a priority of the request information.

16. The terminal device of claim 15, wherein the priority of the request information is predefined.

17. A chip, comprising:
a processor configured to execute computer programs stored in a memory, to enable a first terminal equipped with the chip to:
generate coordination information; and
send the coordination information to a second terminal;
wherein the coordination information is used for coordinating with the second terminal to perform resource selection or resource reselection, and the coordination information is generated under triggering of a preset condition, or the coordination information is sent under triggering of the preset condition.

18. The chip of claim 17, wherein in terms of sending the coordination information to the second terminal, the processor is configured to enable the first terminal equipped with the chip to:
send the coordination information to the second terminal according to a priority of the coordination information.

19. The chip of claim 18, wherein the priority of the coordination information is predefined.

20. The chip of claim 17, wherein in terms of sending the coordination information to the second terminal, the processor is configured to enable the first terminal equipped with the chip to:
send the coordination information to the second terminal within a first time period, wherein the first time period is a running duration of a first timer.
